(19) United States
(12) Patent Application Publication
(10) Pub. No.: US 2025/0035492 A1
(43) Pub. Date: Jan. 30, 2025

(54) TEMPERATURE-BASED TAMPER DETECTION

(71) Applicant: Texas Instruments Incorporated, Dallas, TX (US)

(72) Inventor: Anand Kumar G, Bengaluru (IN)

(21) Appl. No.: 18/918,466

(22) Filed: Oct. 17, 2024

Related U.S. Application Data
(63) Continuation of application No. 17/355,992, filed on Jun. 23, 2021, now Pat. No. 12,146,801.

(51) Int. Cl. G01K 7/42; G01K 1/022; G06F 12/16

(52) U.S. Cl. CPC G01K 7/425; G01K 1/022; G06F 12/16

(57) ABSTRACT

A device includes first and second circuits. The first circuit includes a temperature sensor to measure a device temperature. The second circuit operates to send an enable signal to the first circuit to cause the temperature sensor to measure the device temperature; and, in response to not receiving at least one of a ready signal and the device temperature from the first circuit within a set amount of time, output a tamper event signal and a timeout event signal, and disable a valid data signal.

### CROSS-REFERENCE TO RELATED APPLICATION

This U.S. patent application is a continuation of, and claims priority to, U.S. patent application Ser. No. 17/355,992, filed Jun. 23, 2021, the content of which is incorporated by reference herein.

### BACKGROUND

As the Internet of Things (IoT) spreads and devices with sensitive information become ubiquitous, many microcontrollers used in IoT and other secure embedded applications include tamper detection systems to protect the sensitive information from attack. One method of tampering is to vary the device operating temperature drastically, outside the valid operating temperature range, causing the device to malfunction. For example, a temperature-based tamper attack can cause the device to boot in an insecure manufacturing state rather than a secure in-field state, allowing the attacker to manipulate device operation. As another example, a temperature-based tamper attack can freeze a device, allowing the attacker to exploit data permanence and access cryptographic keys and sensitive information stored on a random-access memory cell. Many devices include a temperature sensing system to detect temperature-based tamper attacks and deploy appropriate counter measures, such as deleting the sensitive information or presenting an alert to a user.

However, those techniques depend on a reliable temperature sensing circuit and cannot detect a subsequent temperature-based tamper attack after a prior attack that disables the temperature sensing circuit. For example, an alpha radiation attack can disrupt enable and ready signals within the temperature sensing circuit, and a supply voltage attack can disable voltage-sensitive components within the temperature sensing circuit.

### SUMMARY

In an example, a device includes first and second circuits. The first circuit includes a temperature sensor to measure a device temperature. The second circuit operates to send an enable signal to the first circuit to cause the temperature sensor to measure the device temperature; and, in response to not receiving at least one of a ready signal and the device temperature from the first circuit within a set amount of time, output a tamper event signal and a timeout event signal, and disable a valid data signal.

In an example, a circuit includes a trigger generator, an interface, a timer and an error code generator coupled to the timer. The trigger generator is configured to transmit an enable signal. The interface is configured to receive a ready signal and a temperature signal indicative of a device temperature. The timer, which is coupled to the interface, is configured to start counting a set time in response to the enable signal being transmitted.

In response to not receiving the ready signal and the temperature signal within a set amount of time, the timer is configured to transmit a tamper event signal to the error code generator and to transmit a timeout event signal to the interface, and the circuit is configured to de-assert a valid data signal.

In an example, a method includes initiating, by a logic circuit, a timer in response to the logic circuit transmitting an enable signal; determining, by the logic circuit, whether at least one of a ready signal and a device temperature signal is received within a set amount of time as measured by the timer; de-asserting the enable signal in response to determining that neither the device temperature signal nor the ready signal is received within the set amount of time; outputting a tamper event signal and an error code in response to determining that neither the device temperature signal nor the ready signal is received within the set amount of time; and de-asserting a valid data signal in response to determining that neither the device temperature signal nor the ready signal is received within the set amount of time.

Other examples and implementations are described below.

### BRIEF DESCRIPTION OF THE DRAWINGS

For a detailed description of various examples, reference will now be made to the accompanying drawings in which:

FIG. 1 illustrates a block diagram of an example temperature-based tamper detection system for a secure microcontroller.

FIG. 2A illustrates a block diagram of an example temperature sensor circuit in the temperature-based tamper detection system shown in FIG. 1.

FIG. 2B illustrates an example temperature sensor for the temperature sensor circuit shown in FIG. 2A.

FIG. 3 shows a timing diagram of signals in the temperature-based tamper detection system shown in FIG. 1 during normal operation.

FIG. 4 shows a timing diagram of signals in the temperature-based tamper detection system shown in FIG. 1 in response to a tamper attempt.

The same reference number is used in the drawings for the same or similar (either by function and/or structure) features.

### DETAILED DESCRIPTION

The disclosed temperature sensing devices are able to respond to tamper attacks that disable the temperature sensor as well as temperature-based tamper attacks and include a security timeout counter and an error code generator. The security timeout counter initiates a countdown when the temperature sensing processes is triggered by an enable signal. During normal operation, the device temperature is measured before the countdown ends, and the timer resets. However, in response to a tamper attack that disables the temperature sensor, the countdown ends without the device temperature being measured. In response to the countdown ending, the security timeout counter outputs a tamper event signal and a timeout signal. The error code generator receives the tamper event signal and generates an error code. In response to the timeout signal, the enable signal is deactivated.

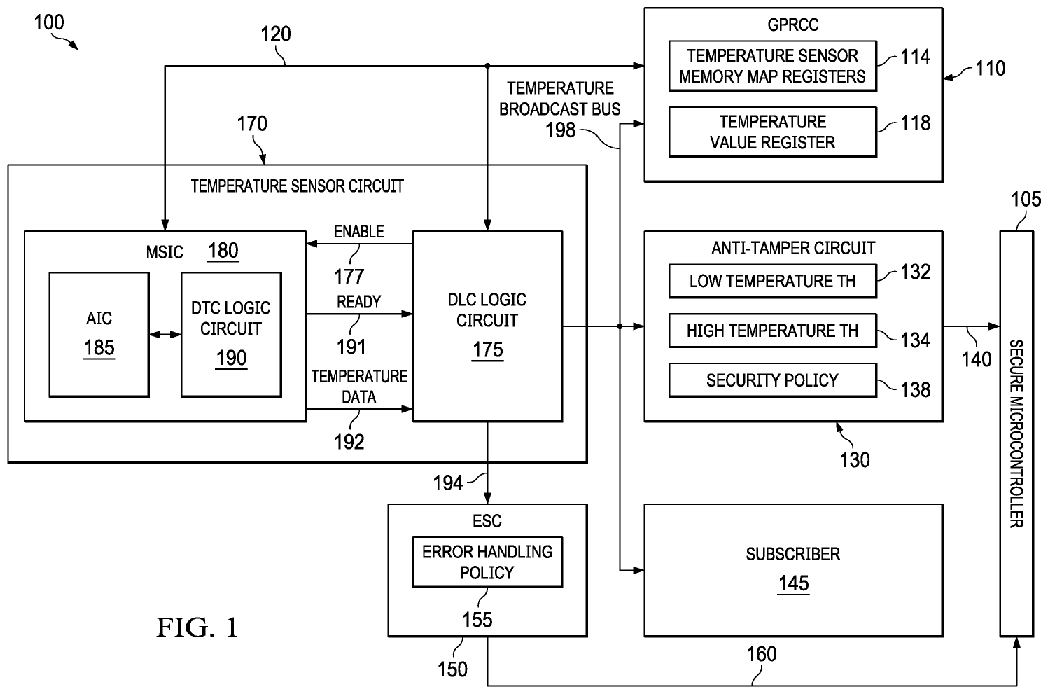

FIG. 1 illustrates a block diagram of an example temperature-based tamper detection system 100 for a secure microcontroller 105, which can be on the same or a different die than the temperature-based tamper detection system 100. The tamper detection system 100 includes a global power reset control circuit (GPRCC) 110, an anti-tampering circuit 130, a subscriber 145, an error signaling circuit 150, and a temperature sensor circuit 170. The GPRCC 110 includes a set of temperature sensor memory map registers (TS MMRs) 114 and a temperature value register 118. The set of TS MMRs 114 store values indicative of how frequently to measure an ambient temperature of the system and/or a temperature of one or more particular components in the system, trimming values for the temperature sensor circuit 170, etc. These values can be predetermined during device bootup by the manufacturer, programmed by the user over a serial link to the die containing the system 100, or both. The temperature value register 118 stores the current system temperature as measured by the temperature sensor circuit 170. The GPRCC 110 can use the current system temperature stored in the temperature value register 118 to adjust a supply voltage or a clocking signal (not shown) output by the GPRCC 110 to another circuit.

The anti-tampering circuit 130 includes a low temperature threshold register 132, a high temperature threshold register 134, and a security policy memory 138. The security policy memory 138 may be any appropriate non-transitory computer readable storage medium, such as a static random-access memory (SRAM). The low temperature threshold register 132 stores a value indicative of a lowest expected temperature for the system 100 and can be programmed by a user over a serial link to the die containing the system 100. The high temperature threshold register 134 stores a value indicative of a highest expected temperature for the system 100 and can be set by a user. The lowest expected temperature and the highest expected temperature outline an expected temperature range for the system 100, such that a tamper attempt adjusting the temperature of the system outside the expected temperature range is flagged. The security policy memory 138 stores data indicative of the desired security response to a tamper attack. For example, the security policy memory 138 stores data indicative that, responsive to the temperature being outside the temperature range defined by the highest and lowest expected temperatures, system 100 should erase data (e.g., sensitive data) from the secure microcontroller 105, trigger an alarm, etc.

The subscriber 145 is any appropriate circuit that uses temperature readings from the temperature sensor circuit 170. For example, the subscriber 145 can be a clock circuit with a frequency tracking loop that uses temperature, a sample-and-hold based bandgap reference voltage generator that determines the duty cycle of the sample-and-hold circuit based on the measured system temperature, etc. The error signaling circuit 150 includes an error handling policy memory 155 that stores data indicative of a desired response to a tamper event signal 194 from the temperature sensor circuit 170, such as resetting or interrupting an operation by a central processing unit of the secure microcontroller 105, logging the frequency of tamper event signals, etc. The error handling policy memory 155 may be any appropriate non-transitory computer readable storage medium, such as an SRAM.

In this example, the temperature sensor circuit 170 includes a digital loosely-coupled (DLC) logic circuit 175 and a mixed signal integrated circuit (MSIC) 180. The DLC logic circuit 175 and the MSIC 180 receive trimming data, testing and configuration information, etc. from the GPRCC 110 over bus 120. For example, the DLC logic circuit 175 and the MSIC 180 receive data over bus 120 that is indicative of how frequently to measure the temperature. The DLC logic circuit 175 provides a valid data signal and temperature data over temperature broadcast bus 198 to the temperature value register 118 in the GPRCC 110, the anti-tamper circuit 130, and the subscriber 145. The MSIC 180 includes an analog integrated circuit (AIC) 185 and a digital tightly coupled (DTC) logic circuit 190. The DTC logic circuit 190 is designed specifically to work in tandem with the AIC 185 and thus is tightly coupled to the AIC 185. In contrast, the DLC logic circuit 175 is designed to work with a variety of different components, including the GPRCC 110, the anti-tamper circuit 130, the subscriber 145, the error signaling circuit 150, and the MSIC 180, such that it is loosely coupled to multiple circuits rather than tightly coupled to a single circuit or function.

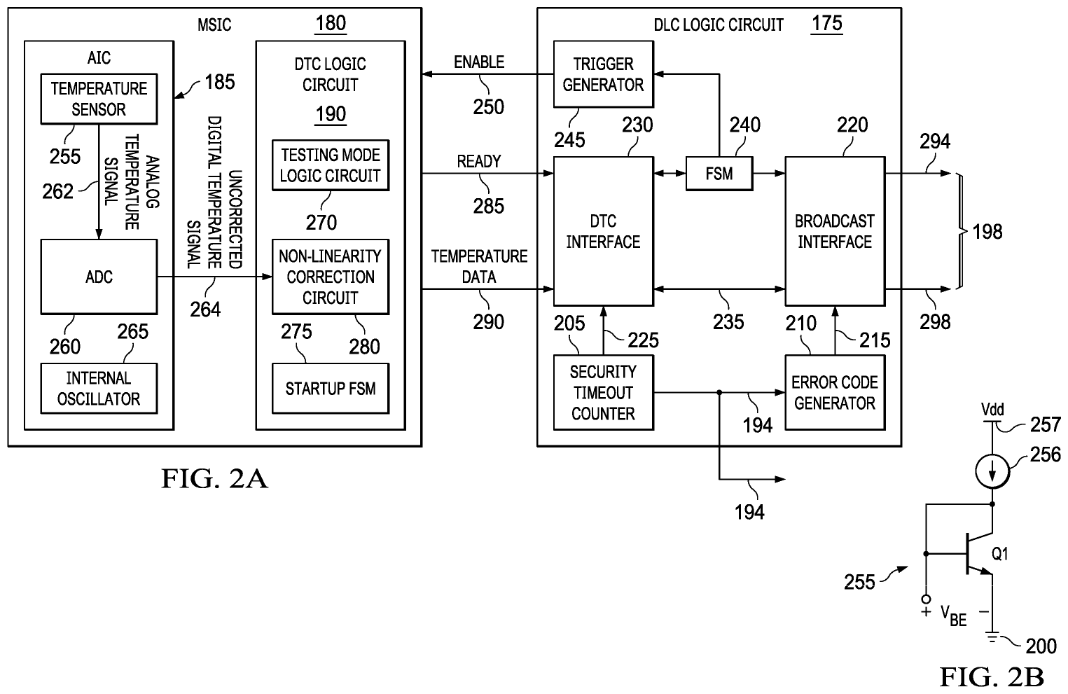

The AIC 185 measures the system temperature (as explained below), and the DTC logic circuit 190 implements a control state machine for the AIC 185 and performs non-linearity corrections on the temperature data from the AIC 185. For example, the temperature data from the AIC 185 can include non-linearities due to manufacturing tolerances in the temperature sensor, and the DTC logic circuit 190 can correct for those known non-linearities. The DLC logic circuit 175 enables a temperature sensing operation by the MSIC 180 using the enable signal 177, and receives the temperature data 192 and a ready signal 191 from the DTC logic circuit 190. The DLC logic circuit 175 broadcasts the valid data signal and the temperature data on temperature broadcast bus 198 in response to the ready signal 191 from the DTC logic circuit 190. Operation of the temperature sensing circuit 170 is described further herein with respect to FIG. 2.

The GPRCC 110 updates the temperature data stored in the temperature value register 118 based on the broadcasted temperature data. The anti-tamper circuit 130 compares the temperature data received from the temperature broadcast bus 198 to the low temperature threshold stored in the low temperature register 132 and to the high temperature threshold stored in the high temperature register 134 to determine whether the system temperature is outside the expected temperature range for the system 100. In response to the temperature being outside the expected range, the anti-tamper circuit 130 outputs a control signal on bus 140 to cause the secure microcontroller 105 to perform an action based on the security policy stored in the memory 138. For example, the secure microcontroller 105 may respond to the control signal by erasing some or all of its data (e.g., data considered to be sensitive enough that the data should be erased).

The subscriber 145 receives the broadcasted temperature data and performs any appropriate action based on the temperature data. For example, where the subscriber 145 is a clock circuit with a frequency tracking loop, the temperature data can be used to adjust operation of the frequency tracking loop. The DLC logic circuit 175 also provides a tamper event signal 194 to the error signaling circuit 150, which outputs a control signal on bus 160 to cause the secure microcontroller 105 to perform an action based on the error handling policy stored in memory 155. For example, the error signaling circuit 150 outputs a control signal to interrupt operation of a central processing unit of the secure microcontroller 105.

FIG. 2A illustrates a block diagram of an example temperature sensor circuit 170 in the temperature-based tamper detection system 100 shown in FIG. 1. The DLC logic circuit 175 includes a security timeout counter 205, an error code generator 210, a broadcast interface (I/F) 220, a DTC I/F 230, a finite state machine (FSM) 240, and a trigger generator 245. The AIC 185 includes a temperature sensor 255, an analog-to-digital converter (ADC) 260, and an internal oscillator 265 for clocking. The DTC logic circuit 190 includes a testing mode logic circuit 270, a startup FSM 275, and a non-linearity correction circuit 280. In the DLC logic circuit 175, the FSM 240 causes the trigger generator 245 to generate an enable signal 250.

The DTC logic circuit 190 in the MSIC 180 receives the enable signal 250 and the startup FSM 275 causes the AIC 185 to measure the system temperature using the temperature sensor 255, shown in FIG. 2B. The temperature sensor 255 includes a bipolar junction transistor (BJT) Q1 configured as a diode by short-circuiting the collector and base junctions of Q1. The emitter junction is coupled to a common mode voltage node 200 (e.g., a ground node). The collector junction is further coupled to a current source 256, which applies a constant current to the BJT Q1. The resulting voltage difference Vbe between the base and emitter junctions is dependent on temperature. The voltage difference represents an analog temperature signal. In other implementations, any appropriate temperature sensing technique may be used. The ADC 260 converts the analog temperature signal 262 into an uncorrected digital temperature signal 264, which is provided to DTC logic circuit 190. The non-linearity correction circuit 280 corrects for non-linearities in the uncorrected digital temperature signal 264 before the DTC logic circuit 190 transmits a ready signal 285 and temperature data 290 to the DTC I/F 230 in the DLC logic circuit 175.

During normal operation, the FSM 240 causes the DTC I/F 230 to forward the valid temperature data 235 to the broadcast I/F 220, which outputs a valid data signal 294 and the system temperature data 298 to the temperature broadcast bus 198. If a tamper attack has prevented the MSIC 180 from sensing the temperature, the ready signal 285 is not transmitted and the DLC logic circuit 175 continues to wait for the ready signal 285. In response to the enable signal 250 being transmitted, the security timeout counter 205 begins a timer. The security timeout counter 205 may implement the timer using a countdown or a count up. The length of the timer can be predetermined during device bootup by the manufacturer based on how long it takes the MSIC 180 to provide the temperature data 290 in response to the enable signal 250. For example, if the MSIC 180 takes four clock cycles to provide the temperature data 290, the length of the timer may be set to a value greater than four clock cycles (e.g. 32 clock cycles).

In response to the ready signal 285 not being asserted before the countdown expires, the security timeout counter 205 outputs the tamper event signal 194 to the error signaling circuit 150 and to the error code generator 210. The security timeout counter 205 also outputs a timeout event signal 225 to the DTC I/F 230, which forwards the timeout event signal 225 to the FSM 240. The FSM 240 causes the trigger generator 245 to stop generating the enable signal 250 in response to the timeout event signal 225. The error code generator 210 generates an error code 215 based on the tamper event signal 194 and provides it to the broadcast I/F 220. The broadcast I/F 220 then outputs the error code in place of the temperature data 298 on temperature broadcast bus 198.

To test that the security timeout counter 205, the error code generator 210, the error handling policy stored in memory 155 of the error signaling circuit 150, and the security policy stored in memory 138 of the anti-tamper circuit 130 are working correctly, the GPRCC 110 sends a testing signal to the DTC logic circuit 190 over bus 120. In response to the testing signal, the testing mode logic circuit 270 prevents the DTC logic circuit 190 from sending the ready signal 285 to DLC logic circuit 175, which allows the security timeout counter 205 to expire and output the tamper event signal 194 and timeout event signal 225, confirming that the security timeout counter 205 is operating properly. The error code generator 210 receives the tamper event signal 194 and generates an error code 215 based on it, confirming the error code generator 210 operates properly. The broadcast I/F 220 outputs the error code on temperature broadcast bus 198 to the anti-tamper circuit 130, which outputs a control signal on bus 140 to cause the secure microcontroller 105 to perform an operation based on the security policy stored in memory 138, confirming the anti-tamper circuit 130 operates properly. The error signaling circuit 150 receives the tamper event signal 194 from the security timeout counter 205, and outputs a control signal on bus 160 to cause the secure microcontroller 105 to perform an operation based on the error handling policy stored in memory 155, confirming the error signaling circuit 150 operates properly. If any of the security timeout counter 205, error code generator 210, anti-tamper circuit 130, and error signaling circuit 150 do not operate as expected, additional troubleshooting and repairs or replacements can be made.

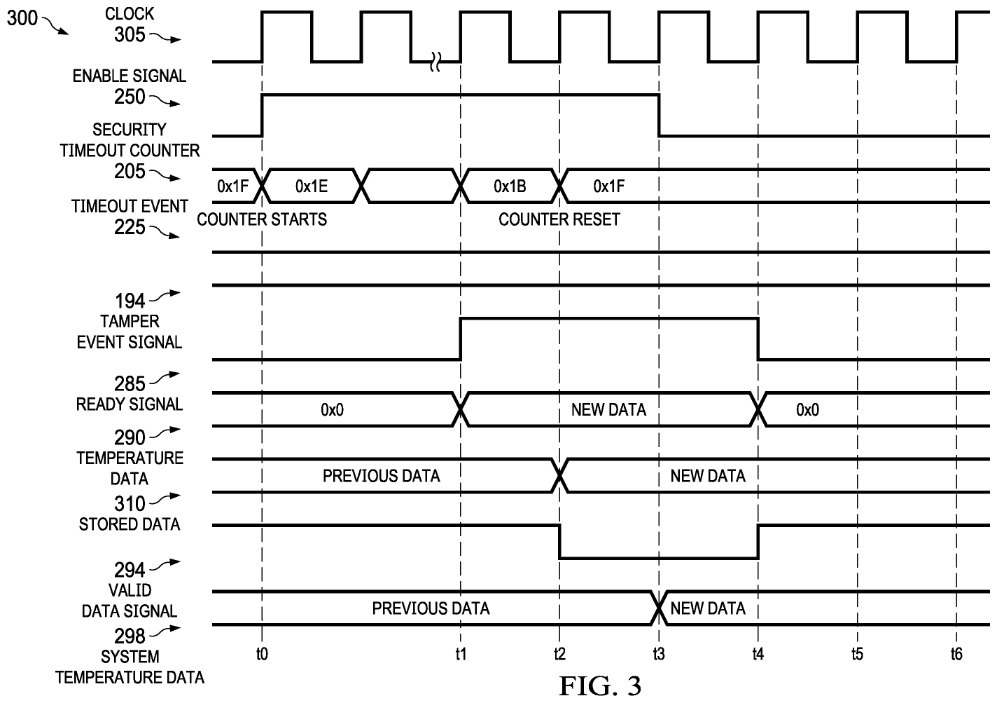

FIG. 3 shows a timing diagram 300 of signals in the temperature-based tamper detection system 100 shown in FIG. 1 during normal operation. In this example, the FSM clock runs at 32 kilohertz (kHz) indicated by the clock signal 305. At t0, the trigger generator 245 sends the enable signal 250 to the DTC logic circuit 190 in the MSIC 180, and the security timeout counter 205 begins counting down from 31, 0x1F in hexadecimal, in this example. The AIC 185 senses the system temperature and provides the updated temperature data 290 to the DTC logic circuit 190, which enables the ready signal 285 at t1 and provides the updated temperature data 290 to the DTC I/F 230.

In response to receiving the ready signal 285, the security timeout counter 205 stops decrementing, in this example at 27, that is, 0x1B in hexadecimal, and so the security timeout event 225 and tamper event signal 194 remain inactive. The security timeout counter value 205 resets to 31, 0x1F in hexadecimal, at time t2 and maintains it because the enable signal 250 is disabled at t3. The security timeout counter value 205 will begin counting down again when the enable signal 250 is sent to the DTC logic circuit 190 again.

The DLC logic circuit 175 stores the updated temperature data as the stored data 310 beginning at time t2. At the same time, the DLC logic circuit 175 disables the valid data signal 294, such that the GPRCC 110, the anti-tamper circuit 130, and the subscriber 145 receiving the valid data signal 294 over the temperature broadcast bus 198 know that updated temperature data is forthcoming. The DLC logic circuit 175 begins transmitting the temperature data 198 over temperature broadcast bus 120 at t3, and enables the valid data signal 294 at t4. The ready signal 285 disables at t4, when the DTC logic circuit 190 finishes transmitting the updated temperature 290 to the DLC logic circuit 175.

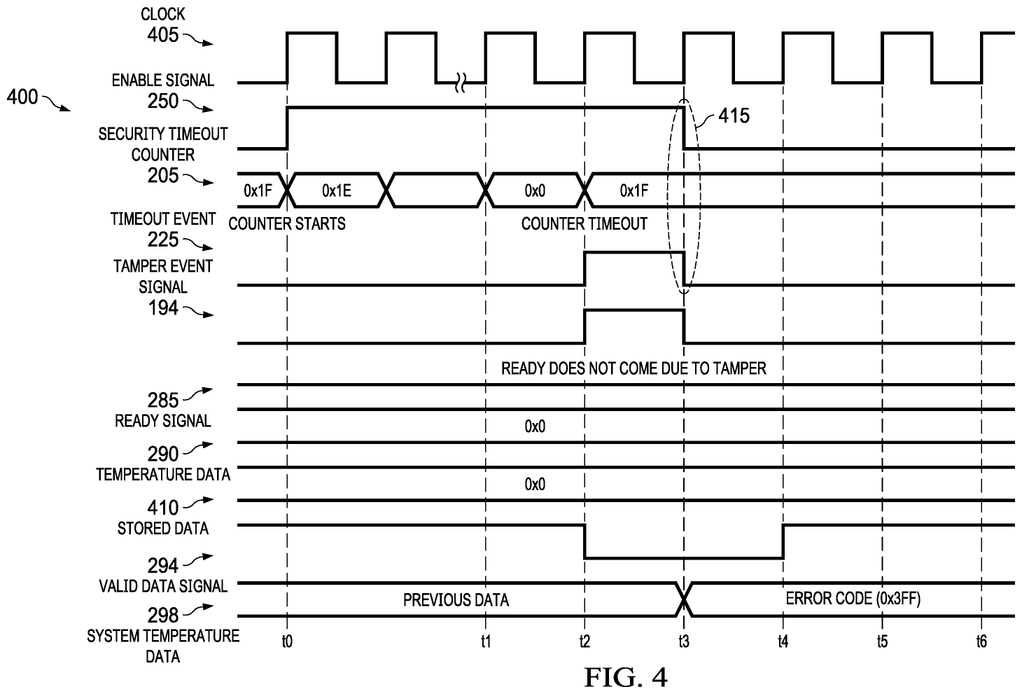

FIG. 4 shows a timing diagram 400 of signals in the temperature-based tamper detection system 100 shown in FIG. 1 in response to a tamper attempt. As in the example described in FIG. 3, the FSM clock runs at 32 kHz indicated by the clock signal 405. At t0, the trigger generator 245 sends the enable signal 250 to the DTC logic circuit 190 in the MSIC 180, and the security timeout counter 205 begins counting down from 31, 0x1F in hexadecimal, in this example. The AIC 185 is unable to provide the ready signal 285 and the updated temperature data 290 due to a tamper attack, and so the security timeout counter value 205 reaches zero at t1 before resetting to 31 at t2.

In response to the security timeout counter value 205 reaching zero, the timeout event 225 and the tamper event signal 194 are enabled and the data valid signal 294 is disabled at t2. The error code generator 210 outputs an error code 215 to broadcast I/F 220, which provides the error code 215 in place of the temperature data 298 on bus 198 at t3. The timeout event 225 and the enable signal 250 are disabled at t3, as indicated by the callout 415. The tamper event signal 194 is disabled at t3 as well. The GPRCC 110, the anti-tamper circuit 130, and the subscriber 145 individually determine whether the data provided on temperature broadcast bus 198 is temperature data or an error code and what action to perform in response. For example, the GPRCC 110 compares the received data to the known error code, and in response to a match, the GPRCC 110 does not update the temperature value register 118.

Similarly, the anti-tamper circuit 130 compares the received data to the known error code, and in response to a match, outputs a control signal on bus 140 to cause the secure microcontroller 105 to perform an operation based on the security policy stored in memory 138, such as erasing sensitive data. The subscriber 145 compares the received data to the known error code, and in response to a match, does not perform an operation based on the temperature. Returning to the example where the subscriber 145 is a clock circuit with a frequency tracking loop, the subscriber 145 does not use the error code to adjust operation of the frequency tracking loop and instead maintains current operation. The error signaling circuit 150 receives the tamper event signal 194 from the security timeout counter 205, and outputs a control signal on bus 160 to cause the secure microcontroller 105 to perform an operation based on the error handling policy stored in memory 155, such as interrupting operation of a central processing unit of the secure microcontroller 105.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead. For example, a p-type metal-oxide-silicon field effect transistor (“MOSFET”) may be used in place of an n-type MOSFET with little or no changes to the circuit. Furthermore, other types of transistors may be used (such as bipolar junction transistors (BJTs)).

Unless otherwise stated, “about,” “approximately,” or “substantially” preceding a value means +/−10 percent of the stated value. Modifications are possible in the described examples, and other examples are possible within the scope of the claims.

Modifications are possible in the described embodiments, and other embodiments are possible, within the scope of the claims.

What is claimed is:

1. A device comprising:
a first circuit including a temperature sensor configured to measure a device temperature; and
a second circuit configured to:
send an enable signal to the first circuit to cause the temperature sensor to measure the device temperature; and
in response to not receiving at least one of a ready signal and the device temperature from the first circuit within a set amount of time, output a tamper event signal and a timeout event signal, and disable a valid data signal.

2. The device of claim 1, wherein the second circuit is further configured to output the tamper event signal and the timeout event signal, and disable the valid data signal in response to not receiving both the ready signal and the device temperature from the first circuit within the set amount of time.

3. The device of claim 2, wherein the second circuit is further configured to disable the enable signal in response to not receiving the ready signal and the device temperature within the set amount of time.

4. The device of claim 1, further comprising an error signaling circuit configured to perform an operation in response to the tamper event signal.

5. The device of claim 2, further comprising:
a timer configured to count down the set amount of time and output the tamper event signal and timeout event signal in response to not receiving the ready signal and the device temperature from the first circuit within the set amount of time; and
an error code generator configured to generate an error code based on the tamper event signal.

6. The device of claim 5, further comprising:
an anti-tamper circuit coupled to the second circuit and configured to:
receive the error code when it is generated and to receive the temperature data when it is received within the set amount of time;
store data indicative of an expected temperature range within which the device is configured to operate; and
store a security policy indicating a desired security response to the error code.

7. The device of claim 6, wherein the anti-tamper circuit is further configured to:
perform an operation based on the stored security policy in response to receiving the error code.

8. The device of claim 6, wherein the anti-tamper circuit is further configured to:
compare the device temperature to the expected temperature range; and
in response to the device temperature being outside the expected temperature range, perform an operation based on the stored security policy.

9. The device of claim 1, wherein the first circuit includes an analog circuit and a digital circuit, in which the analog circuit includes the temperature sensor and an analog-to-digital converter (ADC) coupled to the temperature sensor, and the digital circuit includes a correction circuit.

10. The device of claim 9, wherein:
the temperature sensor is configured to measure the device temperature, and output an analog temperature signal;
the ADC is configured to convert the analog temperature signal to an uncorrected digital temperature signal;
the correction circuit is configured to perform a linearity correction operation on the digital temperature signal to generate a corrected digital temperature signal; and
the digital circuit is configured to output the corrected digital temperature signal as the device temperature.

11. A circuit comprising:
a trigger generator configured to transmit an enable signal;
an interface configured to receive a ready signal and a temperature signal indicative of a device temperature;
a timer coupled to the interface and configured to start counting a set time in response to the enable signal being transmitted; and
an error code generator coupled to the timer;
wherein, in response to not receiving the ready signal and the temperature signal within a set amount of time,
the timer is configured to transmit a tamper event signal to the error code generator and to transmit a timeout event signal to the interface, and
the circuit is configured to de-assert a valid data signal.

12. The circuit of claim 11, further comprising a broadcast interface having a broadcast bus on which the valid data signal is transmitted.

13. The circuit of claim 12, further comprising a finite state machine configured to cause the trigger generator to transmit the enable signal at an initial time and to stop transmitting the enable signal in response to the timeout event signal.

14. The circuit of claim 13, wherein the error code generator is configured to generate an error code based on the tamper event signal and transmit the error code to the broadcast interface.

15. The circuit of claim 14, wherein the broadcast interface is configured to output the error code when the tamper event signal is received by the error code generator.

16. The circuit of claim 15, wherein the broadcast interface is configured to output the temperature signal when the tamper event signal is not received by the error code generator.

17. A method comprising:
initiating, by a logic circuit, a timer in response to the logic circuit transmitting an enable signal;
determining, by the logic circuit, whether at least one of a ready signal and a device temperature signal is received within a set amount of time as measured by the timer;
de-asserting the enable signal in response to determining that neither the device temperature signal nor the ready signal is received within the set amount of time;
outputting a tamper event signal and an error code in response to determining that neither the device temperature signal nor the ready signal is received within the set amount of time; and
de-asserting a valid data signal in response to determining that neither the device temperature signal nor the ready signal is received within the set amount of time.

18. The method of claim 17, wherein the error code is indicative of a temperature outside of an operating temperature range of the device.

19. The method of claim 17, further comprising:
asserting the valid data signal and the device temperature signal in response to determining that at least one of the device temperature signal and the ready signal is received within the set amount of time.
